(19) United States
(12) Patent Application Publication
(10) Pub. No.: US 2025/0128620 A1
(43) Pub. Date: Apr. 24, 2025

(54) TRANSFORMERLESS BIDIRECTIONAL DC CHARGER FOR ELECTRIC VEHICLES

(71) Applicant: THE REGENTS OF THE UNIVERSITY OF COLORADO, A BODY CORPORATE, Denver, CO (US)

(72) Inventors: Robert Erickson, Boulder, CO (US); Aaron Rogers, Longmont, CO (US)

(73) Assignee: BREK ELECTRONICS CORP., Broomfield, CO (US)

(21) Appl. No.: 18/722,054

(22) PCT Filed: Dec. 20, 2022
(86) PCT No.: PCT/US2022/053539

§ 371 Date: Jun. 20, 2024

Related U.S. Application Data
(60) Provisional application No. 63/291,785, filed on Dec. 20, 2021.

(51) Int. Cl. B60L 53/22; B60L 53/62; B60L 55/00; H02M 1/00

(52) U.S. Cl. CPC B60L 53/22; B60L 53/62; B60L 55/00; H02M 1/0043; H02M 1/0067; B60L 2210/10; B60L 2210/44

(57) ABSTRACT

A transformerless bidirectional power converter is provided. The bidirectional power converter, in one implementation, interfaces split-phase ac, such as the 240 V ac commonly available in the United States, to dc terminals for charging and discharging the battery of an electrified vehicle. The bidirectional power converter enables and controls bidirectional power flow, to charge the battery from the ac power and to supply power from the battery to the ac, possibly with variable power factor.

### CROSS-REFERENCE TO RELATED APPLICATIONS

This application claims the benefit of U.S. provisional application No. 63/291,785, entitled “Transformerless bidirectional de charger for electric vehicles” and filed on 20 Dec. 2021, which is hereby incorporated by reference as though fully set forth herein.

### BACKGROUND

### a. Field

The instant disclosure relates to a transformerless bidirectional power converter system adapted to interface an AC system to a DC battery, such as on an electric vehicle.

### b. Background

Safety standards limit the allowable common-mode current that flows into a vehicle from a charger. A typical approach employs transformer isolation to reduce this common-mode current. However, transformer isolation increases the cost of the charger system. It is desirable to provide a solution that meets the safety standards without requiring the expense of transformer isolation.

### BRIEF SUMMARY

A transformerless bidirectional power converter is provided. The bidirectional power converter, in one implementation, interfaces split-phase ac, such as the 240 V ac commonly available in the United States, to dc terminals for charging and discharging the battery of an electrified vehicle. The bidirectional power converter enables and controls bidirectional power flow, to charge the battery from the ac power and to supply power from the battery to the ac, possibly with variable power factor.

In one embodiment, for example, a transformerless bidirectional power converter system adapted to interface an AC system to a DC battery is provided. The transformerless bidirectional power converter system comprises a DC bus, an inverter, and a bidirectional DC-DC converter. The DC bus comprises DC link capacitors connected from a positive bus terminal to a negative bus terminal. The DC bus includes circuitry adapted to perform energy storage during conversion of the ac power to non-pulsating DC power. The inverter comprises at least two pair of inverter transistors adapted to switch with pulse-width modulation (PWM) control via an inverter controller. The bidirectional DC-DC converter comprises at least two pair of DC-DC converter transistors adapted to switch with pulse-width modulation control via a DC-DC converter controller to control the dc currents flowing through a plurality of inductors connected between the switching elements and a pair of DC output terminals.

In another embodiment, a method of controlling a transformerless bidirectional power converter system adapted to interface an AC system to a DC battery is provided. The method comprises providing a transformerless bidirectional power converter system. The transformerless bidirectional power converter system comprises a DC bus, an inverter, and a bidirectional DC-DC converter. The DC bus comprises DC link capacitors connected from a positive bus terminal to a negative bus terminal. The DC bus includes circuitry adapted to perform energy storage during conversion of the ac power to non-pulsating DC power. The inverter comprises at least two pair of inverter transistors. The bidirectional DC-DC converter comprises at least two pair of DC-DC converter transistors. The method further comprises switching the at least two pair of inverter transistors with pulse-width modulation control via an inverter controller; and switching the at least two pair of DC-DC converter transistors with pulse-width modulation control via a DC-DC converter controller to control the de currents flowing through a plurality of inductors connected between the switching elements and a pair of DC output terminals.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 is a block diagram of an example bidirectional DC charger that interfaces split-phase AC to the DC battery of an electrified vehicle.

FIG. 2 is a block diagram of an example embodiment of a bidirectional DC charger.

FIG. 3 is a block diagram showing further details of the dc-dc converter of the bidirectional power converter shown in FIG. 2.

FIG. 4 is a block diagram of an embodiment of a bidirectional power converter in which inductor of both the inverter and the dc-dc converter are coupled.

FIG. 5 illustrates doubling of the inverter and dc-dc converter modules, effectively doubling the rated power.

FIG. 6 illustrates the current waveform for one of the inverter inductors, over a half ac line cycle.

FIG. 7 illustrates the current waveform for one of the dc-dc converter coupled inductor windings, over a half ac line cycle.

FIG. 8 illustrates how the ac line voltage (line to neutral) and de bus capacitor voltage (one half of the dc bus) vary over a half line cycle.

### DETAILED DESCRIPTION

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used throughout, the singular forms “a,” “an” and “the” include plural referents unless the context clearly dictates otherwise. Thus, for example, reference to “a” component can include two or more such components unless the context indicates otherwise. Also, the words “proximal” and “distal” are used to describe items or portions of items that are situated closer to and away from, respectively, a user or operator such as a surgeon. Thus, for example, the tip or free end of a device may be referred to as the distal end, whereas the generally opposing end or handle may be referred to as the proximal end.

All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

The term “substantially” as used herein may be applied to modify any quantitative representation which could permissibly vary without resulting in a change in the basic function to which it is related.

A transformerless bidirectional power converter is provided. The bidirectional power converter, in one implementation, interfaces split-phase ac, such as the 240 V ac commonly available in the United States, to de terminals for charging and discharging the battery of an electrified vehicle. The bidirectional power converter enables and controls bidirectional power flow, to charge the battery from the ac power and to supply power from the battery to the ac, possibly with variable power factor.

In one implementation, the bidirectional power converter is adapted to provide a solution having low cost, low volume, low weight, and high efficiency, that is well suited to domestic manufacturing.

An implementation of a bidirectional power converter can also take advantage of new technologies in wide bandgap power semiconductor devices, such as silicon carbide (SiC) power MOSFETs, and high power planar magnetics, using converter circuit topologies and control strategies that achieve the above goals.

Safety standards limit the allowable common-mode current that flows into a vehicle from a charger. The prior art usually employs transformer isolation to reduce this common-mode current. However, elimination of the isolation transformer can enable higher efficiency, lower cost, lower size, and lower weight. In one implementation, meeting the common-mode current limits in a transformerless approach provides an appropriate circuit topology with appropriate control.

In one embodiment, a charger controls the common-mode currents through a circuit topology and control algorithm to minimize or reduce the switching frequency voltage node variations with respect to a neutral voltage.

In one embodiment, planar magnetics are used in a bidirectional power converter. Planar magnetics are low profile inductor or transformer elements that employ printed circuit board (PCB) traces as windings, and ferrite cores that are placed around these windings via PCB cutouts. High power planar magnetics become a significant solution when the converter circuit and its control allow the planar magnetics to have low turns and low inductance. In one embodiment, SiC MOSFETs are used in power electronics and are adapted operate at switching frequencies over 100 kHz at hundreds of volts or higher with peak efficiencies over 98%. These high switching frequencies, plus the introduction of coupled inductor filter elements, can enable the use of planar magnetics.

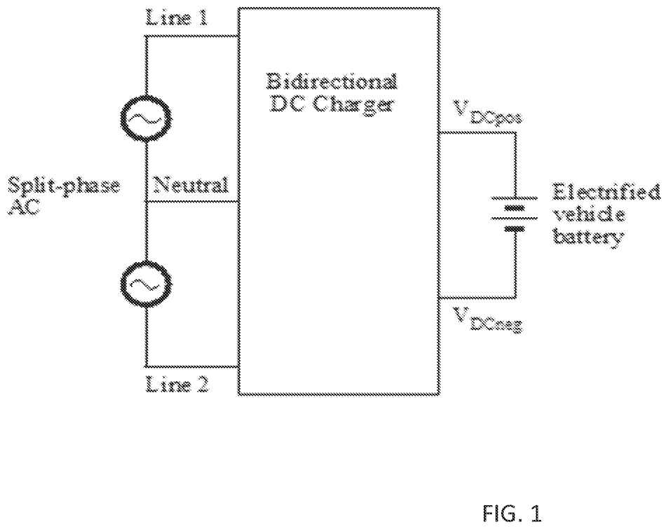

FIG. 1 is a block diagram of an example bidirectional DC charger that interfaces split-phase AC to the DC battery of an electrified vehicle. The bidirectional DC charger embodiment shown in FIG. 1 includes a transformerless power converter system that interfaces a single-phase or split-phase ac system to a dc battery on an electrified vehicle, to function as a bidirectional DC charger. The bidirectional DC charger is adapted to receive AC power from the AC system, converting this power to DC, and charging the battery (“grid to vehicle” operation). Also, the bidirectional DC charger is adapted to receive DC power from the battery, converting this power to AC, and supplying AC power to the AC system (“vehicle to grid” operation). Under normal conditions, vehicle-to-grid operation occurs when the AC system is derived from a utility grid. It also is possible to supply emergency power to the AC system, such as when the utility grid has failed. In that case, a switch (not shown) is used to isolate the AC system from the utility grid, and the bidirectional DC charger supplies power from the battery to the AC system.

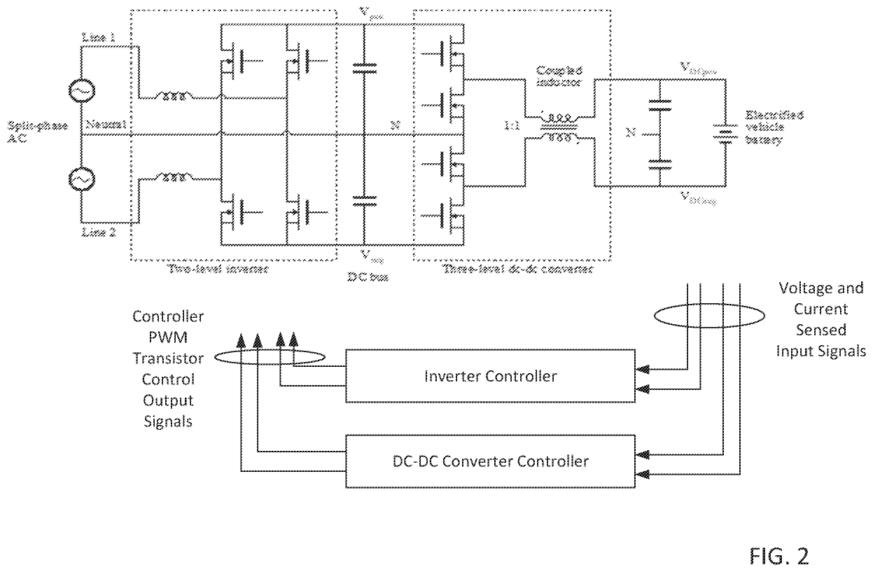

FIG. 2 is a block diagram of an example embodiment of a bidirectional DC charger. In this embodiment, the bidirectional DC charger provides a basic realization of a bidirectional DC charger. A DC bus includes DC link capacitors connected from a positive (Vpos) bus terminal to the neutral point, and from a negative (Vneg) bus terminal to the neutral point. These DC link capacitors perform the energy storage function to enable the conversion of single-phase ac power to nonpulsating DC power. A two-level inverter includes at least two pairs of transistors that function as switching elements with pulse-width modulation (PWM) control. This inverter configuration employs two-level switching: the voltages at the midpoints between the switching elements can be either Vpos or Vneg, depending on the conducting states of the switching elements.

The duty cycles of these switching elements are varied by a controller to control the ac currents flowing through inductors connected between the switching elements and the AC input terminals Line1 and Line2. The inverter controller generates PWM signals that control the gate drivers of the inverter transistors. The inverter controller employs current sensors that sense the inverter inductor currents, and voltage sensors that sense the AC line voltages and DC bus voltages.

In FIG. 2, a three-level dc-dc converter controls the current flowing between the DC bus and the battery. This converter includes at least two pairs of transistors that function as switching elements with PWM control. The duty cycles of these switching elements are varied by a controller to control the de currents flowing through inductors connected between the switching elements and the battery terminals V_{DCpos} and V_{DCneg}. The DC-DC controller generates PWM signals that control the gate drivers of the DC-DC converter transistors. The DC-DC controller employs current sensors that sense the DC-DC converter inductor currents, and voltage sensors that sense the battery voltage and DC bus voltages. The inverter control and DC-DC converter control functions may be implemented in a single microcontroller IC or in separate microcontroller ICs.

In the battery charging (grid-to-vehicle) mode: (1) the DC-DC converter controller adjusts its pulse-width modulation control to regulate the battery charging current to follow a setpoint command; (2) the inverter controller adjusts its pulse-width modulation to regulate the AC system current to follow an AC current setpoint command that is synchronized to the AC system voltage, and (3) the AC current setpoint command is adjusted as necessary to regulate the DC bus voltage.

In the vehicle-to-grid mode: (1) the DC-DC converter controller adjusts its pulse-width modulation control to regulate the battery discharge current to follow a setpoint command; (2) the inverter controller adjusts its pulse-width modulation to regulate the AC system current to follow an AC current setpoint command that is synchronized to the AC system voltage, and (3) the AC current setpoint command is adjusted as necessary to regulate the DC bus voltage.

In the off-grid mode when a switch has isolated the AC system from the utility grid: (1) the DC-DC converter controller adjusts its pulse-width modulation control to regulate the battery discharge current to follow a DC current setpoint command; (2) the inverter controller adjusts its pulse-width modulation to regulate the AC system voltage to follow an AC voltage setpoint command, and (3) the DC current setpoint command is adjusted as necessary to regulate the DC bus voltage.

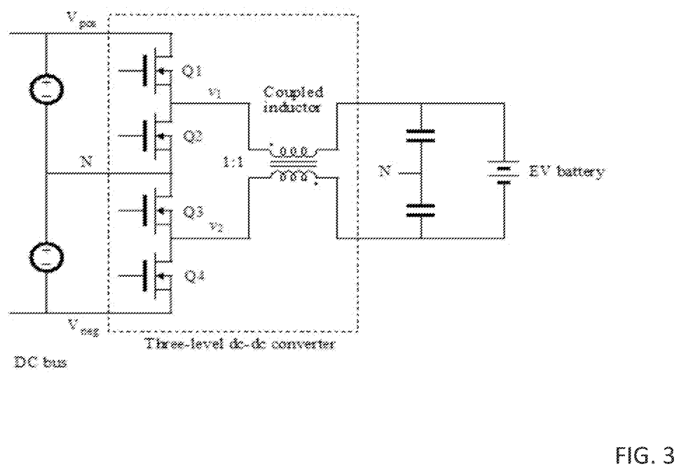

FIG. 3 is a block diagram showing further details of the dc-dc converter of the bidirectional power converter shown in FIG. 2. Transistors Q1 and Q2 produce a switched voltage v₁ at the centerpoint between these switching elements; the voltage at v₁ is equal to either the positive bus voltage Vpos or the neutral voltage N, depending on whether Q1 or Q2 conducts. Likewise, transistors Q3 and Q4 are produce a switched voltage v₂ at the centerpoint between these switching elements; the voltage at v₂ is equal to either the negative bus voltage Vneg or the neutral voltage N, depending on whether Q3 or Q4 conducts. Inductor windings connect the switched voltages to the DC output terminals; the magnitude of the dc output current can be controlled through control of the PWM duty cycles of the switching elements.

In this embodiment, the following switching sequence is employed: The controller turns on transistors Q1 and Q4 and turns off transistors Q2 and Q3, for a time duration DTₛ where D is the duty cycle and Tₛ is the switching period. The controller then turns off transistors Q1 and Q4 and turns on transistors Q2 and Q3, for a time duration (1−D)Tₛ. With this control sequence, the common-mode voltage (v₁+v₂)/2 is equal to the neutral voltage at all times, and the common-mode voltage applied to the DC output terminals ideally has no ac common-mode component.

With the above PWM switching sequence, the instantaneous voltages applied across the inductor windings of FIG. 3 are equal, and hence the two inductors can be coupled on a common core. Coupling the inductors reduces the number of required cores by a factor of two, and also reduces the total inductor current ripple in the windings by a factor of two. FIG. 3 indicates the relative polarities of the coupled windings. Coupling the inductors also tends to equalize the positive and negative dc bus voltages.

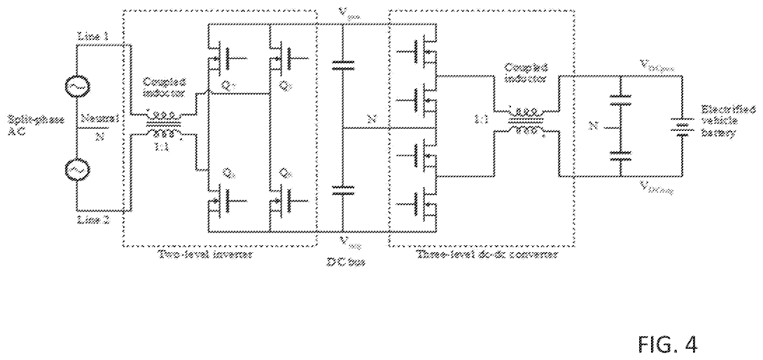

FIG. 4 is a block diagram of an embodiment of a bidirectional power converter in which inductor of both the inverter and the dc-dc converter are coupled. In this embodiment, the controller can turn on Q5 and Q8 during a first switching interval, with Q6 and Q7 turned off. During a second switching interval, the controller turns off Q5 and Q8, and turns on Q6 and Q7. Again, this control sequence allows coupling of the filter inductors while maintaining zero ac variation of the common-mode component of the inverter switch node voltages.

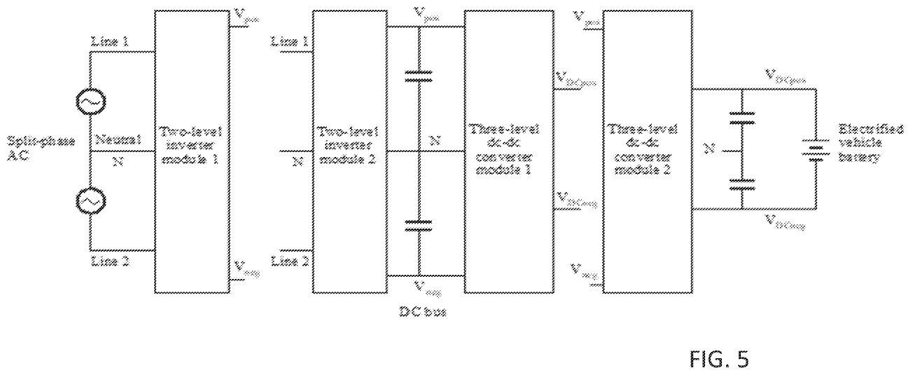

In another embodiment, parallel phase-shifted converter modules are used. FIG. 5 illustrates doubling of the inverter and dc-dc converter modules, effectively doubling the rated power. In this embodiment, each inverter module or dc-dc converter module is the corresponding circuit illustrated in FIG. 2 or 4. Parallel-connected modules are operated with switching waveforms that are phase shifted by 180°, leading to partial cancellation of the inductor current switching harmonics. Additionally, the switching frequency can be varied along the ac sine wave, which spreads out the spectrum of the current switching harmonics and further reduces their amplitude. These measures allow reduction of the amount of EMI (electromagnetic interference) filtering that is needed.

### DESIGN EXAMPLE

A sample bidirectional charger interfaces a 240 V 60 Hz AC system to a dc battery having a nominal voltage of 400 V. The parallel phase-shifted approach of FIG. 5 is employed, with the inductors of the dc-dc converter modules coupled as in FIG. 3. The rated current of the AC system interface is 48 A.

The DC bus employs 250 V electrolytic capacitors for its positive and negative halves, with a total of 15,000 μF in each half.

The coupled inductors of the dc-dc converter modules consist of 3 turns per winding in a six-layer PCB having 3 oz copper and employing one turn per layer. Ferrite N49 EILP 64 planar cores are gapped to 9 μH per three-turn winding.

The inductors of the inverter modules each consist of 5 turns per winding, with ferrite N49 EILP 64 planar cores gapped to 19.5 μH per inductor.

All power transistors are onsemi NVH4L045N065SC1 SiC MOSFETs, rated 650 V and 45 mΩ. These transistors operate with a variable switching frequency that is 100 kHz at the peak of the ac sine wave, and 310 kHz at the zero crossing, with switching period that varies in proportion to the ac line voltage.

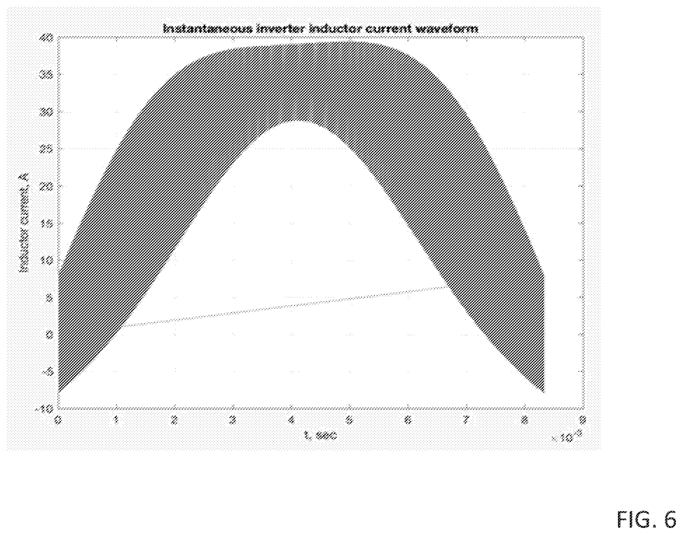

A model of this design was developed in MATLAB, and waveforms and losses were predicted. FIG. 6 illustrates the current waveform for one of the inverter inductors, over a half ac line cycle. This waveform includes switching ripple plus the desired underlying 60 Hz sinusoidal component.

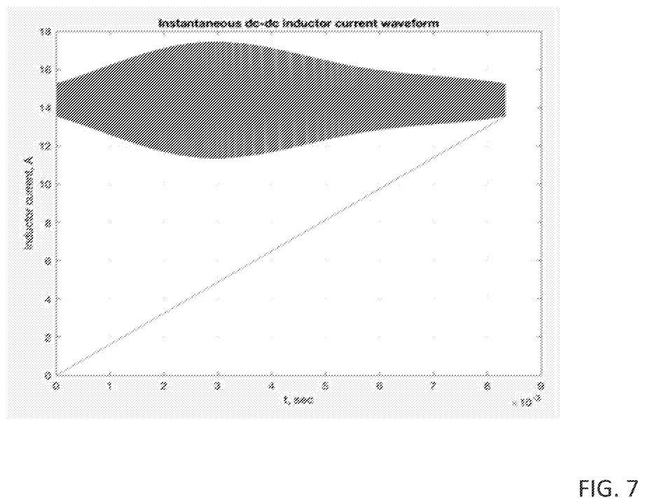

FIG. 7 illustrates the current waveform for one of the dc-dc converter coupled inductor windings, over a half ac line cycle. The switching frequency of this converter is synchronized to the inverter switching frequency and varies in the same way. The waveform includes switching ripple plus the desired underlying dc component.

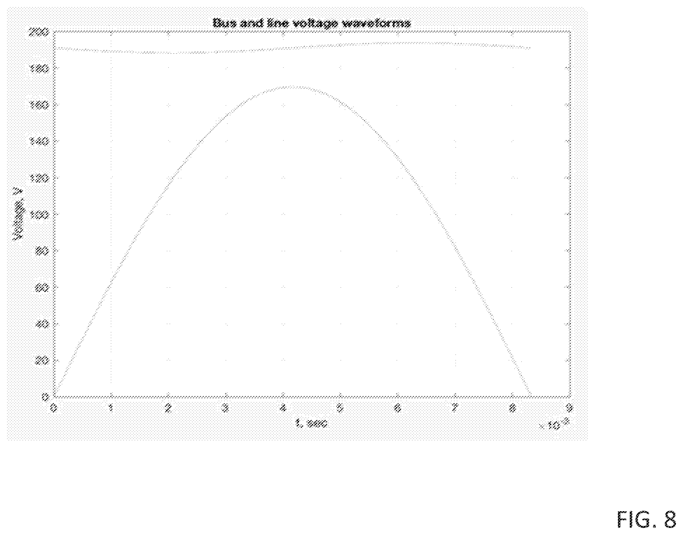

FIG. 8 illustrates how the ac line voltage (line to neutral) and de bus capacitor voltage (one half of the dc bus) vary over a half line cycle.

The predicted efficiency of this design at this operating point is 98.45%.

What is claimed is:

1. A transformerless bidirectional power converter system adapted to interface an AC system to a DC battery wherein the system comprises:
a DC bus comprising DC link capacitors connected from a positive bus terminal to a negative bus terminal, wherein the DC bus includes circuitry adapted to perform energy storage during conversion of the ac power to non-pulsating DC power;
an inverter comprising at least two pair of transistors adapted to switch with pulse-width modulation (PWM) control via an inverter controller; and
a bidirectional DC-DC converter comprising at least two pair of transistors adapted to switch with pulse-width modulation control via a DC-DC converter controller to control the dc currents flowing through a plurality of inductors connected between the switching elements and a pair of DC output terminals.

2. The system of claim 1, wherein the DC battery is a DC battery of an electric vehicle.

3. The system of claim 1, wherein the plurality of inductors of the bidirectional DC-DC converter comprises a pair of coupled inductors.

4. The system of claim 1, wherein the plurality of inductors of the inverter comprises planar inductors.

5. The system of claim 1, wherein the plurality of inductors of the bidirectional DC-DC converters comprises planar inductors.

6. The system of claim 1, wherein the plurality of inductors of the inverter comprises a pair of coupled inductors.

7. The system of claim 1, wherein the AC system comprises at least one of a single-phase AC system and a split-phase AC system.

8. The system of claim 7, wherein the AC system comprises a grid AC system.

9. The system of claim 7 or 8, wherein the system comprises a switch adapted to isolate the AC system from a utility grid AC system.

10. The system of claim 1, wherein the DC bus includes a center node connected to the DC link capacitors and to at least two pair of transistors of the bidirectional DC-DC converter.

11. The system of claim 10, wherein the DC-DC controller operates the at least two pair of transistors synchronously.

12. The system of claim 10, wherein the center node of the DC bus is connected to a neutral point of the AC system.

13. The system of claim 12, wherein the AC system comprises at least one of a single-phase AC system and a split-phase AC system.

14. The system of claim 1, wherein the bidirectional DC-DC converter comprises a plurality of interleave modules, each interleave module comprising a pair of switches and an inductor, and wherein the DC-DC controller operates the interleaves using phase-shifted PWM.

15. The system of claim 1, wherein the inverter comprises a plurality of interleave modules, each interleave module comprising a pair of switches and an inductor, and wherein the inverter controller operates the interleaves using phase-shifted PWM.

16. The system of claim 15, wherein the controller varies the PWM switching frequency, with switching period that varies in proportion to the AC line voltage.

17. The system of claim 1, wherein, in a battery charging (grid-to-vehicle) mode: (1) the DC-DC converter controller adjusts a DC-DC converter pulse-width modulation control to regulate the battery charging current to follow a setpoint command; (2) the inverter controller adjusts an inverter pulse-width modulation to regulate the AC system current to follow an AC current setpoint command that is synchronized to the AC system voltage, and (3) the AC current setpoint command is adjusted to regulate the DC bus voltage.

18. The system of claims 1 and 17, wherein, in a vehicle-to-grid mode: (1) the DC-DC converter controller adjusts its pulse-width modulation control to regulate the battery discharge current to follow a setpoint command; (2) the inverter controller adjusts its pulse-width modulation to regulate the AC system current to follow an AC current setpoint command that is synchronized to the AC system voltage, and (3) the AC current setpoint command is adjusted as necessary to regulate the DC bus voltage.

19. The system of claims 1, 17, and 18, in an off-grid mode: (1) the DC-DC converter controller is adapted to adjust a DC-DC pulse-width modulation control to regulate the battery discharge current to follow a DC current setpoint command; (2) the inverter controller is adapted to adjust an inverter pulse-width modulation to regulate the AC system voltage to follow an AC voltage setpoint command, and (3) the DC current setpoint command is adapted to be adjusted to regulate the DC bus voltage.

20. The system of claim 1, wherein the inverter controller is adapted to control ac currents flowing through a plurality of inductors connected between the switching elements and a pair of AC input terminals.

21. The system of claim 1, wherein the inverter controller is adapted to regulate an AC system voltage.

22. The system of claim 1, wherein the inverter controller and the DC-DC controller are implemented as components of a single controller.

23. A method of controlling a transformerless bidirectional power converter system adapted to interface an AC system to a DC battery wherein the method comprises:
providing a transformerless bidirectional power converter system comprising:
DC bus comprising DC link capacitors connected from a positive bus terminal to a negative bus terminal, wherein the DC bus includes circuitry adapted to perform energy storage during conversion of the ac power to non-pulsating DC power;
an inverter comprising at least two pair of inverter transistors; and
a bidirectional DC-DC converter comprising at least two pair of DC-DC converter transistors;
switching the at least two pair of inverter transistors with pulse-width modulation control via an inverter controller;
switching the at least two pair of DC-DC converter transistors with pulse-width modulation control via a DC-DC converter controller to control the de currents flowing through a plurality of inductors connected between the switching elements and a pair of DC output terminals.

24. The method of claim 23, wherein the DC battery is a DC battery of an electric vehicle.

25. The method of claim 23, wherein the plurality of inductors of the bidirectional DC-DC converter comprises a pair of coupled inductors.

26. The method of claim 23, wherein the plurality of inductors of the inverter comprises planar inductors.

27. The method of claim 23, wherein the plurality of inductors of the bidirectional DC-DC converters comprises planar inductors.

28. The method of claim 23, wherein the plurality of inductors of the inverter comprises a pair of coupled inductors.

29. The method of claim 23, wherein the AC system comprises at least one of a single-phase AC system and a split-phase AC system.

30. The method of claim 29, wherein the AC system comprises a grid AC system.

31. The method of claim 29 or 30, wherein the system comprises a switch adapted to isolate the AC system from a utility grid AC system.

32. The method of claim 23, wherein the DC bus includes a center node connected to the DC link capacitors and to at least two pair of transistors of the bidirectional DC-DC converter.

33. The method of claim 32, wherein the DC-DC controller operates the at least two pair of transistors synchronously.

34. The method of claim 32, wherein the center node of the DC bus is connected to a neutral point of the AC system.

35. The method of claim 34, wherein the AC system comprises at least one of a single-phase AC system and a split-phase AC system.

36. The method of claim 23, wherein the bidirectional DC-DC converter comprises a plurality of interleave modules, each interleave module comprising a pair of switches and an inductor, and wherein the DC-DC controller operates the interleaves using phase-shifted PWM.

37. The method of claim 23, wherein the inverter comprises a plurality of interleave modules, each interleave module comprising a pair of switches and an inductor, and wherein the inverter controller operates the interleaves using phase-shifted PWM.

38. The method of claim 37, wherein the controller varies the PWM switching frequency, with switching period that varies in proportion to the AC line voltage.

39. The method stem of claim 23, wherein, in a battery charging (grid-to-vehicle) mode: the DC-DC converter controller adjusts a DC-DC converter pulse-width modulation control to regulate the battery charging current to follow a setpoint command; the inverter controller adjusts an inverter pulse-width modulation to regulate the AC system current to follow an AC current setpoint command that is synchronized to the AC system voltage, and the AC current setpoint command is adjusted to regulate the DC bus voltage.

40. The method of claims 23 and 39, wherein, in a vehicle-to-grid mode: the DC-DC converter controller adjusts its pulse-width modulation control to regulate the battery discharge current to follow a setpoint command; the inverter controller adjusts its pulse-width modulation to regulate the AC system current to follow an AC current setpoint command that is synchronized to the AC system voltage, and the AC current setpoint command is adjusted as necessary to regulate the DC bus voltage.

41. The method of claims 23, 39, and 40, in an off-grid mode: (1) the DC-DC converter controller is adapted to adjust a DC-DC pulse-width modulation control to regulate the battery discharge current to follow a DC current setpoint command; (2) the inverter controller is adapted to adjust an inverter pulse-width modulation to regulate the AC system voltage to follow an AC voltage setpoint command, and (3) the DC current setpoint command is adapted to be adjusted to regulate the DC bus voltage.

42. The method of claim 23, wherein the inverter controller is adapted to control ac currents flowing through a plurality of inductors connected between the switching elements and a pair of AC input terminals.

43. The method of claim 23, wherein the inverter controller is adapted to regulate an AC system voltage.

44. The method of claim 23, wherein the inverter controller and the DC-DC controller are implemented as components of a single controller.
